(19) United States
(12) Patent Application Publication
(10) Pub. No.: US 2023/0216744 A1
(43) Pub. Date: Jul. 6, 2023

(54) EVOLUTIONARY NETWORK RE-CONFIGURATION

(71) Applicant: BRITISH TELECOMMUNICATIONS PUBLIC LIMITED COMPANY, London (GB)

(72) Inventors: Jonathan ROSCOE, London (GB); Gabriele GELARDI, London (GB)

(21) Appl. No.: 18/000,860

(22) PCT Filed: Jun. 2, 2021
(86) PCT No.: PCT/EP2021/064836

§ 371 Date: Dec. 6, 2022

(30) Foreign Application Priority Data
Jun. 9, 2020 (GB) 2008756.5

(51) Int. Cl. H04L 41/14; H04L 41/5025; H04L 41/40

(52) U.S. Cl. CPC H04L 41/145; H04L 41/5025; H04L 41/40

(57) ABSTRACT

A computer implemented method of adapting a configuration of a software defined network to improve a measure of network performance towards an objective measure of performance, the network including a plurality of network nodes communicating via the network, the method including each node applying an evolutionary algorithm to generate a candidate adjusted configuration for the network and, responsive to a determination that the candidate provides an improvement to the measure of network performance, the node storing the candidate in a distributed database accessible to the nodes for access by other nodes; each node accessing candidate adjusted configurations in the distributed database and determining a performance of the network provided by each accessed candidate, wherein each node records the determined performance provided by a candidate in the database in association with the candidate, such that a candidate adjusted configuration providing a greatest improvement to the measure of network performance is selected by the nodes for adapting the configuration of the network.

### PRIORITY CLAIM

The present application is a National Phase entry of PCT Application No. PCT/EP2021/064836, filed Jun. 2, 2021, which claims priority from GB Patent Application No. 2008756.5, filed Jun. 9, 2020 each of which is hereby fully incorporated herein by reference.

### TECHNICAL FIELD

The present disclosure relates to software defined networks and, in particular, reconfiguration of software defined networks.

### BACKGROUND

Software defined networks (SDNs) provide dynamic configuration of physical or virtualized network components such as switches and routers for the purpose of providing network services for network applications. Divided logically into a “data plane”, consisting of network components, and a “control plane”, consisting of logic for configuring and controlling the network components, a particular specification of an SDN configuration by one or more SDN controllers seeks to provide network services in an efficient and reliable manner. The configurability and dynamic nature of SDNs permit regular and/or routine reconfiguration of a network to achieve desired performance goals. In particular, one or more objective measures of performance for a network may be desired.

### SUMMARY

It is therefore desirable to provide for the effective dynamic reconfiguration of an SDN.

According to a first aspect of the present disclosure, there is provided a computer implemented method of adapting a configuration of a software defined network to improve a measure of network performance towards an objective measure of performance, the network including a plurality of network nodes communicating via the network, the method comprising: each node applying an evolutionary algorithm to generate a candidate adjusted configuration for the network and, responsive to a determination that the candidate provides an improvement to the measure of network performance, the node storing the candidate in a distributed database accessible to the nodes for access by other nodes; each node accessing candidate adjusted configurations in the distributed database and determining a performance of the network provided by each accessed candidate, wherein each node records the determined performance provided by a candidate in the database in association with the candidate, such that a candidate adjusted configuration providing a greatest improvement to the measure of network performance is selected by the nodes for adapting the configuration of the network.

In some examples, a determination, by a node, of a performance of the network provided by a candidate adjusted configuration is made by the node executing a simulation of the network in which the candidate adjusted configuration is applied and determining a measure of performance provided by the candidate by measuring a performance of the simulated network.

In some examples, the method further comprises each node sharing a candidate adjusted configuration providing an improvement to the measure of network performance with the other nodes via a distributed data structure accessible to the nodes, each shared candidate having associated a measure of network performance for the network having the candidate adjusted configuration applied, and wherein the evolutionary algorithm is operable based on a population of candidate adjusted configurations in the distributed data structure.

In some examples, the distributed data structure is a distributed hash table.

In some examples, the population of candidate adjustment configurations is a selected subset of candidates in the distributed data structure selected based on the measure of network performance associated with candidates in the distributed data structure.

In some examples, the distributed database is a blockchain data structure.

In some examples, the evolutionary algorithm is a genetic algorithm.

According to a second aspect of the present disclosure, there is provided a computer system including a processor and memory storing computer program code for performing the method set out above.

According to a third aspect of the present disclosure, there is provided a computer program element comprising computer program code to, when loaded into a computer system and executed thereon, cause the computer to perform the method as described above.

### BRIEF DESCRIPTION OF THE DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an arrangement for adapting a configuration of a software defined network (SDN) to improve a measure of network performance towards an objective measure of performance according to an embodiment of the present disclosure.

FIG. 3 is a flowchart of a method for adapting a configuration of a software defined network (SDN) to improve a measure of network performance towards an objective measure of performance according to an embodiment of the present disclosure.

### DETAILED DESCRIPTION

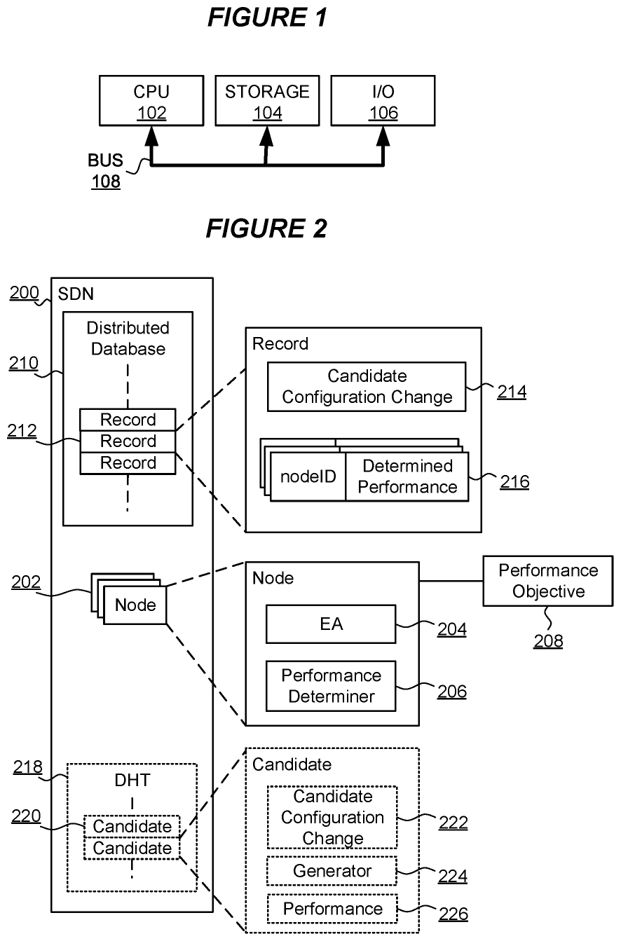

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

FIG. 2 is a component diagram of an arrangement for adapting a configuration of an SDN to improve a measure of network performance towards an objective measure of performance according to an embodiment of the present disclosure. An SDN 200 is provided as a set of communicatively connected physical and/or virtual configurable network components constituting a network. SDN 200 can provide a dynamic configuration of physical or virtualized network components such as switches and routers for the purpose of providing network services for network applications. As will be apparent to those skilled in the art, an SDN is typically divided logically into a “data plane”, consisting of network components, and a “control plane”, consisting of logic for configuring and controlling the network components. A particular specification of an SDN configuration by an SDN controller seeks to provide network services in an efficient and reliable manner.

Embodiments of the present disclosure provide for adapting a configuration of the SDN 200 such as by way of one or more of, inter alia: adapting configuration of one or more SDN controllers of the SDN 200; adapting parameters and/or configuration options of the SDN 200; and adjusting an arrangement of the SD 200.

In some examples, the SDN 200 includes one or more SDN controllers as hardware, software, firmware or combination components or set of components for providing control functionality for a set of physical and/or virtual network components constituting the SDN 200. For example, such components can provide data forwarding, switching and routing facilities. Thus, an SDN controller implements a particular configuration defining rules according to which the configuration of each of at least a subset of the network components are configured. Such rules can include, for example, a routine, forwarding, data flow or switching rule for a network component. Furthermore, network components and networked devices such as network attached devices are operable within and with the SDN 200, and each of these such devices can also be configured according to configuration rules affecting the operation of the SDN 200.

An SDN controller provides interfaces, services and/or facilities for network applications seeking to communicate via one or more communication networks and, along with other network components, is configurable such as by way of parameters, configuration options, instantiation options and the like. For example, an SDN controller can provide flow control for one or more network components using an SDN controller protocol such as OpenFlow. Examples of an SDN controller include: Beacon, a Java-based OpenFlow SDN controller that supports both event-based and threaded operation (see “The Beacon OpenFlow Controller” (David Erickson, Stanford University) available at yuba.stanford.edu; and OpenDaylight from the Linux Foundation (see “Open Daylight as a Controller for Software Defined Networking”, Badotra and Singh, 2015, IJARCS available from www.researchgate.net).

Network applications can communicate via the SDN 200 using communications services as network services provided by the SDN 200 via network components. Each of the network components can be a physical and/or virtualized networking component such as a network switch, router or the like and is configurable, such as by way of flow control, routing control, switching control and the like. Network components include a plurality of measurable metrics that can be indicative of performance and that can be combined aggregated or summarized for the SDN 200 to constitute network performance. Each metric can correspond to a characteristic of a component or network relating to a performance of the component or network. For example, characteristics can include some or all of, inter alia: bandwidth availability; data throughput; a degree of contention; a processor performance; a memory consumption; a memory availability; a measure of temperature; a degree of variability of a performance; a reliability measure; an uptime measure; a downtime measure; and other characteristics as will be apparent to those skilled in the art.

According to embodiments of the present disclosure, a subset of components constituting the SDN 200 cooperate to provide adaptations to a configuration of the SDN 200, such components being referred to as nodes 202 and include any of: one or more controllers of the SDN 200; physical network components of the SDN 200; virtual network components of the SDN 200; and/or network-attached components constituted in the SDN 200. Notably, embodiments of the present disclosure do not preclude that only a subset of such controllers, network components or network-attached components may constitute the set of nodes 202.

Each node 202 operates to adapt a configuration of the SDN 200 to improve a measure of network performance of the SDN 200 towards an objective measure of performance. Such objective measure of performance is a performance objective 208 such as a performance goal, constraint, rule or the like. The performance objective 208 is common to the nodes 202 such as by being commonly accessible to the nodes 202 and/or being stored by or in association with each node 202. For example, the performance objective 208 can be a constraint on a data rate of communications such as a minimum data rate. Alternatively, the performance objective 208 can be number of connections such as a number of simultaneous connections within the SDN 200. Alternatively, the performance objective 208 can relate to a potential attack, malicious action or other threat to the SDN such as a characteristic of an attack such as a ratio of “SYN” (synchronization) to “ACK” (acknowledgement) packets or messages occurring between devices within and/or connected via the SDN 200 (such as may be indicative of a denial of service attack). Other performance objectives will be apparent to those skilled in the art.

Each node 202 includes an evolutionary algorithm 204 as a functional component that may be embodied in hardware, software and/or firmware and is operable to perform an optimization function such as a metaheuristic optimization. For example, the evolutionary algorithm can employ evolutionary software processes such as evolutionary computation including a generic population-based metaheuristic optimization using biologically inspired techniques such as reproduction, mutation, recombination and selection. An example of a suitable evolutionary algorithm is a genetic algorithm such as are known to those skilled in the art such as from “An Introduction to Genetic Algorithms” (Melanie Mitchell, MIT Press, 1996). Genetic algorithms and their applications are known from, inter alia: C. Ahn and R. S. Ramakrishna, “A genetic algorithm for shortest path routing problem and the sizing of populations,”, IEEE Transactions on Evolutionary Computation, Vol. 6, No. 6, pp. 566-579, December 2002; E. Alba and B. Dorronsoro “Solving the Vehicle Routing Problem by Using Cellular Genetic Algorithms,” Proceedings of 2004 European Conference on Evolutionary Computation in Combinatorial Optimization, Coimbra, Portugal, pp 11-20, 2004; A. Starkey, H. Hagras, S. Shakya, and G. Owusu, “A Genetic Algorithm Based Approach for the Simultaneous Optimisation of Workforce Skill Sets and Team Allocation.” in: Bramer M., Petridis M. (eds) Research and Development in Intelligent Systems XXXIII SGAI 2016. Springer; M. Barbosa and M. Jr., “Access Point Design with a Genetic Algorithm,” Proceedings of the Sixth International Conference on Genetic and Evolutionary Computing, Kitakushu, pp. 119-123, 2012; and X. Chen, Z. Bo, X. Dong and S. Shi, “Analysis of ant colony algorithm for finding the optimal circuitous route in the communication network of power system,” Proceedings of the 5th International Conference on Electric Utility Deregulation and Restructuring and Power Technologies (DRPT), Changsha, pp. 2532-2535, 2015.

Genetic Algorithms (GAs) are inspired by nature taking the core ideas of evolution, selection and mutation. In GAs a population will adapt itself to its environment through many generations. Chromosomes are ranked through survival of the fittest, meaning individuals most suited an environment are ranked more highly. Each possible solution to a problem is represented as a chromosome, with a chromosome being made up of a collection of genes with a gene encoding a portion of a specific solution. Genetic information is passed from generation to generation allowing promising genes to thrive. This information is passed on through a process named “crossover” in which two chromosomes are selected to produce offspring chromosomes. These offspring contain a portioning of genes from each parent, and therefore are a combination of both solutions to a problem. Chromosomes are chosen for crossover through a process known as “selection”. Those skilled in the art will be aware that there are numerous different ways that selection could occur, including, inter alia: tournament; or roulette wheel based on their individual fitness score. Fitness is determined by some specific measurable metric which could be a value that needs to be minimized or maximized. If a population of chromosomes surpasses a predesignated size, lowest ranked solutions can be removed from the population allowing only fittest solutions to survive.

Just as in nature there is a random chance of mutation, this happens in GAs when offspring are produced during the crossover process. Mutation is good for the population as it allows for new genes to appear in the population and thus allows the GA to explore new possible solutions. Through multiple generations of crossover, selection and mutation, evolution will begin to occur with dominant chromosomes rising to the top of the genepool. After a predesignated number of generations, or satisfaction of some other suitable stopping criteria, the GA will cease and a solution with the best fitness value will be chosen from the population as the selected solution.

In embodiments of the present disclosure, the evolutionary algorithm 204 is operable on the basis of a population of possible changes to a configuration of the SDN 200 from which candidate adjusted configurations can be generated. Thus, in use, each node 202 generates a candidate adjusted configuration using the evolutionary algorithm 204. For such a candidate adjusted configuration, the node determines, a performance of the SDN 200 with the SDN 200 reconfigured in accordance with the candidate adjusted configuration. This determination is made by way of a performance determiner component 206 of the node, such as a hardware, software, firmware or combination component arranged to determine a measure of performance of the SDN 200 with a candidate adjusted configuration being effected. In a preferred embodiment, the performance determiner 206 includes, uses or has access to, a simulation of the SDN 200 such as a software and/or data model or other suitable simulation of the SDN 200, on which basis to determine a measure of performance of the SDN 200 with the candidate adjusted configuration in effect.

Where a node 202 determines that a candidate adjusted configuration provides an improvement to a performance of the SDN 200 towards the performance objective 208, the node 202 stores the candidate adjusted configuration to a distributed database 210.

The distributed database 210 is a database for storing records that is accessible to the nodes 202 of the SDN 200. While the database 210 is depicted in FIG. 2 as being constituted as part of the SDN 200, this is merely a preferred arrangement and the database 210 could alternatively be provided at least partly outside the SDN 200 but accessible to the nodes 202 of the SDN 200. Each record 212 of the database 210 corresponds to a candidate configuration change generated by a node 202 and includes a specification of the candidate configuration change 214 within the record. For example, a specification of a candidate configuration change 214 can be provided as one or more of: a new complete or partial configuration of the SDN 200; a change to a reference configuration of the SDN 200; and/or a relative change to a configuration of the SDN 200 such as an adjustment to a configuration of the SDN 200.

In one embodiment, the distributed database 210 is provided as a distributed transactional and/or distributed sequential database such as a blockchain. Distributed sequential and/or distributed transactional databases are well known in the field of blockchains and are documented, for example, in “Mastering Bitcoin. Unlocking Digital Crypto-Currencies.” (Andreas M. Antonopoulos, O'Reilly Media, April 2014). For convenience, such a database is herein referred to as a blockchain though it will be appreciated that other suitable databases, data structures or mechanisms possessing the characteristics essential for embodiments of the present disclosure could alternatively be used. A blockchain is a distributed chain of block data structures accessed by a network of nodes, referred to as a miner network. Each block in the blockchain includes a plurality of transaction data structures, each transaction referring or relating to a prior transaction. For example, in one embodiment each blockchain includes a Merkle of hash or digest values for transactions included in the block to arrive at a hash value for the block, which is itself combined with a hash value for a preceding block to generate a chain of blocks (blockchain). A new block of transactions is added to the blockchain by miner software, hardware, firmware or combination systems in a miner network. The miners are communicatively connected to sources of transactions (such as nodes 202 storing candidate configuration changes 214) and access or copy the blockchain. A miner can undertake validation of a substantive content of a transaction (such as any criteria defined therein) and adds a block of new transactions to the blockchain when a challenge is satisfied, typically such challenge involving a combination hash or digest for a prospective new block and a preceding block in the blockchain and some challenge criterion. Thus, miners in the miner network may each generate prospective new blocks for addition to the blockchain. Where a miner satisfies or solves the challenge and validates the transactions in a prospective new block such new block is added to the blockchain. Accordingly, a blockchain provides a distributed mechanism for reliably verifying a data entity such as an entity constituting or representing a node 202. The detailed operation of such blockchains and the function of miners in a miner network is beyond the scope of this specification. The manner in which a blockchain and network of miners operate ensures that only valid transactions are added within blocks to the blockchain in a manner that is persistent within the blockchain. Transactions added erroneously or maliciously are not verifiable by other miners in the network and cannot persist in the blockchain. This attribute of blockchains can be exploited by embodiments of the present disclosure to provide a distributed and reliable assurance for nodes 202 of the authenticity and reliability of information stored in records of the distributed database 210.

In some embodiments, the function of a miner can be performed by the nodes 202 themselves, with nodes 202 serving to validate records in the database 210. Furthermore, in some embodiments the challenge for committing blocks in a blockchain used in an embodiment of the present disclosure can be constituted as a determination that a degree of progress has been made towards the performance objective 208, such as a threshold degree of progress or a threshold differential in performance towards the objective 208.

Thus, in use, nodes 202 generate candidate adjusted configurations for the SDN 200 and store such candidates that constitute improvements in a performance of the SDN 200 towards to the performance objective 208 in the distributed database 200.

Furthermore, nodes 202 access the records 212 in the distributed database 210 to determine, for a candidate configuration change 214 in a record 212, a performance of the candidate configuration change 213. Such determination can be made by a node's performance determiner 206 as previously described, such as by way of a simulation of the SDN 200. Subsequently, nodes 202 record their determined performance along with, in some examples, a node identifier, within or in association with the record 212 for a candidate configuration change 214. In this way, the efficacy of a candidate configuration change 214 in providing an improvement of performance of the SDN 200 towards the performance objective 208 can be identified by way of the performance determinations for each of a plurality of nodes 202 stored in a record 212 for the candidate.

Accordingly, a candidate adjusted configuration 214 in the distributed database 210 providing a greatest improvement to a measure of network performance can be commonly selected by the nodes 202 by reference to the distributed database 210 and the determined performance measures 216 therein. Thus, such candidate adjusted configuration 214 can be retrieved from the distributed database 210 and applied to the SDN 200 to effect a performance improvement.

Notably, the process can be repetitive such that nodes 202 employ their evolutionary algorithms to determine further candidate configuration changes improving on a current performance of the SDN 200 on a continual basis until the performance objective 208 is met or is met to a sufficient, satisfactory extent such as to a predetermined threshold extent.

In one embodiment, the evolutionary algorithm 204 for a node 202 is operable based on a population of candidate adjusted configurations and the population of candidate adjusted configurations can be generated by the nodes 202 themselves. According to such an embodiment, each node 202 is further operable to identify a candidate adjusted configuration that provides an improvement to the measure of network performance (such as by way of the performance delimiter) with the other nodes 202. In some embodiments, such sharing is achieved via a distributed data structure such as a distributed hash table (DHT) 218. A distributed hash table is a distributed data structure accessible via a network such as SDN 200. A distributed hash table is a decentralized distributed data structure for the storage and retrieval of data in the manner of a hash table (e.g. based on (key, value) pairs). A distributed hash table is accessed by the plurality of nodes 202 cooperating in the efficient storage and retrieval of values based on keys generated by a hashing algorithm for the values. Keys are identifiers which map to particular values which in turn can be anything from addresses, to documents, to arbitrary data. Distributed Hash Tables are known in the art as described in detail in, for example, the book “Distributed Hash Table, Theory, Platforms and Applications” (Zhang, H., Wen, Y., Xie, H., Yu, N., Springer, 2013). For example, chapter 2 of the book details distributed hash table theory.

The distributed data structure is accessible to the nodes 202 and each candidate adjusted configuration 220 shared by the distributed data structure includes: a specification 222 of the candidate; preferably an identification 224 of the node 202 that generated the candidate; and a measure 226 of network performance of the SDN 200 having the candidate adjusted configuration applied. For example, the measure of performance 226 can be determined by the performance determiner 206.

According to the embodiment, the distributed data structure 218 provides a population of candidate configuration changes 220 on which basis the evolutionary algorithm 204 of a node 202 can operate, such as a starting population for an evolutionary algorithm 204. In one example, the population is selected from the distributed data structure as candidates 220 that indicate a performance 226 meeting predetermined criteria/criterion, such as a sufficient extent of improvement over a current performance of the SDN 200. Thus, the evolutionary algorithm 204 is operable to generate candidate adjusted configurations constituting continuous improvements to a configuration of the SDN 200 by way of the population selected from the candidates 220 in the distributed data structure 218.

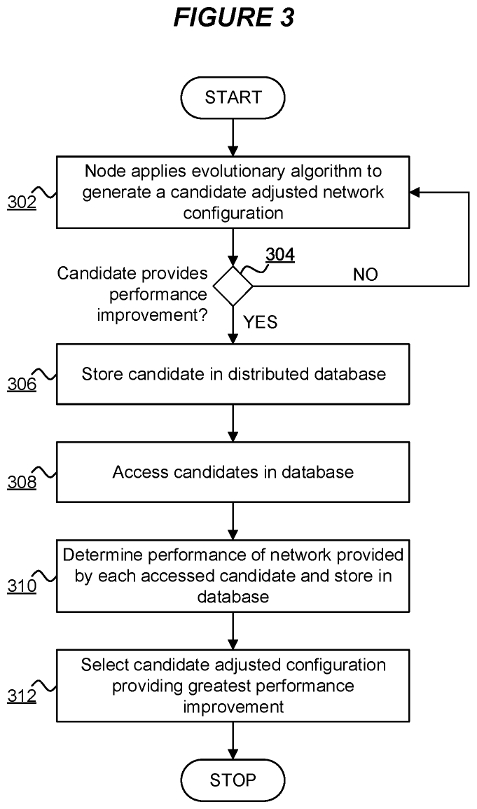

FIG. 3 is a flowchart of a method for adapting a configuration of a software defined network (SDN) to improve a measure of network performance towards an objective measure of performance according to an embodiment of the present disclosure. The method applies to a single node 202 and it will be appreciated that all or a subset of nodes 202 are operable according to the method. Initially, at 302, the node applies the evolutionary algorithm 204 to generate a candidate adjusted configuration for the network. At 304 the method determines if the candidate provides an improvement to the measure of network performance for the SDN 200. If the candidate does provide an improvement, the method proceeds to 306 and the node stores the candidate as a record 212 in the distributed database 210 accessible to the nodes 202 for access by other nodes 202. At 308 the node accesses the records 212 of candidate configuration changes in the database 210. At 310 the node determines a performance of the SDN 200 provided by each accessed candidate and stores the performance in the database 210 in association with the candidate record 212 for the candidate. At 312 the node 202 selects a candidate adjusted configuration providing a greatest improvement to the measure of network performance for adapting the configuration of the SDN 200.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of adapting a configuration of a software defined network to improve a measure of network performance towards an objective measure of performance, the software defined network including a plurality of network nodes communicating via the software defined network, the method comprising:
applying, by each network node of the plurality of network nodes, an evolutionary algorithm to generate a candidate adjusted configuration for the software defined network and, responsive to a determination that the candidate adjusted configuration provides an improvement to the measure of network performance, storing, by the respective network node, the candidate adjusted configuration in a distributed database accessible to the plurality of network nodes for access by others of the plurality of network nodes; and
accessing, by each network node of the plurality of network nodes, the candidate adjusted configurations in the distributed database and determining a performance of the software defined network provided by each accessed candidate adjusted configuration, wherein each network node of the plurality of network nodes records the determined performance provided by a candidate adjusted configuration in the distributed database in association with the candidate adjusted configuration, such that a candidate adjusted configuration providing a greatest improvement to the measure of network performance is selected by the plurality of network nodes for adapting the configuration of the software defined network.

2. The method of claim 1, wherein a determination, by a network node of the plurality of network nodes, of a performance of the software defined network provided by a candidate adjusted configuration is made by the network node executing a simulation of the software defined network in which the candidate adjusted configuration is applied and determining the measure of performance provided by the candidate adjusted configuration by measuring a performance of the simulated software defined network.

3. The method of claim 1, further comprising:
each network node of the plurality of network nodes sharing the candidate adjusted configuration providing an improvement to the measure of network performance with the other network nodes of the plurality of network nodes via a distributed data structure accessible to the plurality of network nodes, each shared candidate adjusted configuration having associated a measure of network performance for the software defined network having the candidate adjusted configuration applied,
wherein the evolutionary algorithm is operable based on a population of candidate adjusted configurations in the distributed data structure.

4. The method of claim 3, wherein the distributed data structure is a distributed hash table.

5-9. (canceled)

10. The method of claim 3, wherein the population of candidate adjustment configurations is a selected subset of the candidate adjustment configurations in the distributed data structure selected based on the measure of network performance associated with the candidate adjustment configurations in the distributed data structure.

11. The method of claim 1, wherein the distributed database is a blockchain data structure.

12. The method of claim 1, wherein the evolutionary algorithm is a genetic algorithm.

13. A computer system comprising:
a processor and memory storing computer program code for adapting a configuration of a software defined network to improve a measure of network performance towards an objective measure of performance, the software defined network including a plurality of network nodes communicating via the software defined network, by:
applying, by each network node of the plurality of network nodes, an evolutionary algorithm to generate a candidate adjusted configuration for the software defined network and, responsive to a determination that the candidate adjusted configuration provides an improvement to the measure of network performance, storing, by the respective network node, the candidate adjusted configuration in a distributed database accessible to the plurality of network nodes for access by others of the plurality of network nodes; and
accessing, by each network node of the plurality of network nodes, the candidate adjusted configurations in the distributed database and determining a performance of the software defined network provided by each accessed candidate adjusted configuration, wherein each network node of the plurality of network nodes records the determined performance provided by a candidate adjusted configuration in the distributed database in association with the candidate adjusted configuration, such that a candidate adjusted configuration providing a greatest improvement to the measure of network performance is selected by the plurality of network nodes for adapting the configuration of the software defined network.

14. A non-transitory computer-readable storage medium storing computer program code to, when loaded into a computer system and executed thereon, cause the computer to adapt a configuration of a software defined network to improve a measure of network performance towards an objective measure of performance, the software defined network including a plurality of network nodes communicating via the software defined network, by:
applying, by each network node of the plurality of network nodes, an evolutionary algorithm to generate a candidate adjusted configuration for the software defined network and, responsive to a determination that the candidate adjusted configuration provides an improvement to the measure of network performance, storing, by the respective network node, the candidate adjusted configuration in a distributed database accessible to the plurality of network nodes for access by others of the plurality of network nodes; and
accessing, by each network node of the plurality of network nodes, the candidate adjusted configurations in the distributed database and determining a performance of the software defined network provided by each accessed candidate adjusted configuration, wherein each network node of the plurality of network nodes records the determined performance provided by a candidate adjusted configuration in the distributed database in association with the candidate adjusted configuration, such that a candidate adjusted configuration providing a greatest improvement to the measure of network performance is selected by the plurality of network nodes for adapting the configuration of the software defined network.
